(19) United States
(12) Patent Application Publication
(10) Pub. No.: US 2004/0025055 A1
(43) Pub. Date: Feb. 5, 2004

(54) Online recognition of robots

(75) Inventors: Youssef Hamadi, Bastia (FR); Maher Rahmouni, (US)

Correspondence Address: HEWLETT-PACKARD DEVELOPMENT COMPANY, Intellectual Property Administration, P.O. Box 272400, Fort Collins, CO, 80527-2400, US

(73) Assignee: HEWLETT-PACKARD DEVELOPMENT COMPANY, L.P.

(21) Appl. No.: 10/421,301

(22) Filed: Apr. 22, 2003

(30) Foreign Application Priority Data
Jul. 31, 2002 (GB) 0217808.5

(51) Int. Cl. G06F 11/30; G06F 15/173

(52) U.S. Cl. 713/201; 709/224

(57) ABSTRACT

Robots accessing a server are identified by allocating an identity tag to a user accessing data stored on the web server in order to identify that user; monitoring the requests made to the server over time by the user identified by the tag; and predicting whether the identified user is a robot based upon one or more properties of the monitored requests predetermined to signify automation of the process of generating the requests.

This invention relates to a method of on-line recognition of robots, sometimes referred to as web crawlers, which are utilising the resources of a server when accessing data stored on the server. It also relates to apparatus for performing the method and to a computer program adapted to carry out the method.

The world wide web is now a well established tool which allows people at one computer—commonly referred to as a client server—to access and display information stored on another computer—commonly known as a web server across a network. The web is a specific example of a network in which requests are made using the http protocol to access information on the web server. The information is stored as a website that comprises one or more WebPages. Each page is written in mark up language such as the hypertext mark up language (html). Any client server connected to the network can therefore access information on any web server provided that a network address is known for the web server since the information stored on the web server is held in a standard format and requests are made in a standard format.

In use, a client server sends out a request across the network which includes a network address for a selected web server and for a particular link defining a page stored at the server. The server then sends back to the browser that made the request the selected web page. The page can then be displayed on a display screen associated with the client server.

A typical page will include a lot of textual information, such as a list of products that are sold by the owner of the web server, or a list of services. There may also be one or more links to other web pages on the server (or another server on the network) which can be accessed from a client server simply by selecting the appropriate link on the page. This use of links allows a user at a client server to quickly navigate around a website on a server.

With the rapid growth of the web there is a need to provide an index of contents that can be found on different web servers. Many companies have established services for looking at the contents of web servers and cataloguing them in a form which can be searched. For example, such a service would allow a user of the search service to look for all web servers on a network that contain a reference to cars. Obviously, such cataloguing is a massive undertaking and with new web servers being established daily and existing servers being continually changed it cannot be performed manually.

To this end, there has been developed a wide number of robots, sometimes referred to as web crawlers or spiders, which have been developed for automating the study and cataloguing of the contents of websites. A robot is a computer program which runs on a processor and automatically traverses the webs hypertext structure by retrieving a WebPage, identifying keywords in the page, and importantly recursively retrieving all documents which are linked to that page. In this way, the robot studies the contents of every page in the Website, and since the process is automated the process is far quicker than could be achieved manually. The information that is obtained is used to produce an index to the Website.

As well as producing searchable indices for websites, robots are commonly used by businesses to check the prices of items offered for sale on websites. This can be used by a business to make sure they are competitive on price with other sites, or to simply search for the lowest price to offer a customer. For the provider of a website which is being searched by a robot—and which may be searched by many robots at once—the resources taken up by the robots can be disastrous. The demands made upon web sites by robots may result in increased access time to the site by genuine customers if resources are limited. Solving this has traditionally meant providing more bandwidth but this is a costly solution.

In the prior art, a solution to the problem of excessive use of resources by robots has been provided by establishing a “netiquette” between robots and the web servers they are trying to access. Ideally all robots would be required to access a text file of the form “/robots.txt” provided at the web server to identify themselves as a robot rather than a genuine user of a browser, and to learn the rules of the website. It is broadly known that most robots do not access this text file since numerous sites deny access to all robots.

It is an object of the present invention to ameliorate the problems presented to the providers of servers by robots.

In accordance with a first aspect the invention provides a method of identifying robots which are accessing a server, the method comprising: allocating an identity tag to a user accessing data stored on the web server in order to identify that user; monitoring the requests made to the server over time by the user identified by the tag; and predicting whether the identified user is a robot based upon one or more properties of the monitored requests predetermined to signify automation of the process of generating the requests.

The invention therefore provides a method of identifying robots by analysing the properties of the requests made by a user. This can be performed in real-time as the user is accessing the data stored on the web server.

The method may comprise determining if a user is a robot based upon one or more of the following properties of the requests made by a user:

(a) the time between requests for data made by an identified user,

(b) the order in which data from the web server is requested by an identified user; and

(c) the number of requests made by a user in a given period of time.

It may employ all three of the steps (a), (b) and (c) to identify robots.

The method may allocate an identity tag to a user by identifying the network address of the user. The identity tag may be the same as the network address, or may be different from the network address.

The network address may be determined by extracting the address from the information contained within each request made by the user, or from an initial request made by a user at the start of a session of requests. In a further alternative, the method may comprise requesting the address from the user prior to permitting any requests in a session.

In case (a) the method may comprise identifying a user as a robot when the time between requests for data is shorter than a predetermined minimum time. This is a possible distinction since a real user would need time to digest a piece of requested information and decide which data to request next. A robot typically parses resources so the time between requests is very short.

An average of the time between two or three or more subsequent requests may be taken and the method may make a decision based upon the average time taken between requests.

In case (b) the method may comprise identifying a user as a robot when the user requests data in a systematic manner which is to an extent independent of the content of the data. For example, if a user is systematically requesting every piece of data linked in a web page from the top of the page to the bottom, or from the bottom to the top, and in the order they are provided on the page, this may be taken to be an indicator of a robot.

A typical robot will open a web page on a server, extract all the links and then open each web page indicated by an extracted link. The order in which the extraction is performed will depend on the way in which the robot is programmed to behave, but is usually systematic and follows a set pattern which the present method may be adapted to identify.

The step (b) may identify requests which correspond to a depth first exploration using a queue of the data held on the server, or perhaps a breadth first exploration using a stack.

The method may comprise predicting which request will be made next by a client assuming that it is a robot, and identifying it as a robot if the next request matches the predicted request. The prediction may be based upon the most recent request, and/or upon a plurality of previous requests. It may be convenient to consider the prediction of future requests to be based upon a history of previous requests.

The prediction may be made by identifying patterns in the sequence and content and/or timing of previous requests and projecting the pattern into the future to predict which request may be made next.

The method may be arranged so that it does not rely upon predictions until a sufficiently large set of previous requests has been obtained.

A reliability or confidence value may be assigned to the prediction which is increased over time as more requests are made.

In case (c) the method may comprise a step of determining the number of requests made within a given time period, or the total length of time over which requests are made. The number, or total time, may then be compared to acceptable maximum number or time values and the client identified as a robot if these values are exceeded.

Clearly, the method may not always need to, or be able to, determine a robot from one of properties (a) to (c) alone, and may need to make a decision based upon a weighted combination of probabilities determined from two or more of these properties of the requests.

The method may be suitable for use in connection with web servers connected to the world wide web.

The method may comprise storing the request information (user identity, request time and request content) in a database, and subsequently analysing the data in the database to identify robots. This analysis may be performed whenever a request is received, or at periodic intervals in time.

In accordance with a second aspect the invention provides a robot identification system for use in combination with a networked server, the system comprising: an identification means adapted to identify a user requesting data from the networked server and allocate an identity tag to that user, a request monitoring means adapted to monitor the requests made to the server over time by the user identified by the tag, and a robot identifying means adapted to identify if the identified user is a robot based upon one or more properties of the requests made by that user that have been monitored by the request monitoring means wherein the one or more properties are predetermined to signify automation of the process of generating the requests.

The robot identifying means may include a timer or counter which counts the elapsed time between subsequent requests made by a user. It may comprise a digital counter.

The robot identification system may be embodied as a computer program which is running on the web server or on a separate server which is connected to the web server. The server may comprise a processor which intercepts requests from users prior to passing the requests on to the web server. It may also be adapted to filter the requests such that not all requests are passed to the web server.

The request monitoring means may be adapted to monitor:

(a) the time between requests for data made by an identified user,

(b) the order in which data from the web server is requested by an identified user; and

(c) the number of requests made by a user in a given period of time.

It may monitor all of (a), (b) and (c) to identify robots.

An area of memory may be provided into which the identity tags, inter-request times and total number of requests made are recorded. The identification means may be adapted to process the information stored in this area of memory to determine if a user is a robot.

The system may allocate an identity tag to a user by identifying the network address of the user. The identity tag may be the same as the network address, or may be different from the network address.

The apparatus may include means for determining the network address by extracting the address from the information contained within each request made by the user, or from an initial request made by a user at the start of a session of requests. In a further alternative, the method may comprise requesting the address from the user prior to permitting any requests in a session.

The robot identification system may produce an alarm signal or other signal in the event that a user is identified as a robot. It may terminate that users session of access to the web server, or may send a warning to the user or may initiate some other action.

In accordance with a third aspect the invention provides a computer program which when running on a processor is adapted to cause the processor to:

(i) allocate an identity tag to a user accessing data stored on the web server in order to identify that user,

(ii) monitor the requests made to the server over time by the user identified by the tag, and

(iii) predict whether the identified user is a robot based upon one or more properties of the monitored requests wherein the one or more properties are predetermined to signify automation of the process of generating the requests.

According to a fourth aspect the invention provides a data carrier which carries a computer program which when running on a processor is adapted to cause the processor to:

(i) allocate an identity tag to a user accessing data stored on the web server in order to identify that user,

(ii) monitor the requests made to the server over time by the user identified by the tag, and

(iii) predict whether the identified user is a robot based upon one or more properties of the monitored requests wherein the one or more properties are predetermined to signify automation of the process of generating the requests.

A non-exhaustive list of data carriers within the scope of the fourth aspect of the invention includes magnetic disks, optical disks (CDs, DVDs) and solid state memory devices.

There will now be described by way of example only one embodiment of the present invention with reference to the accompanying drawings of which:

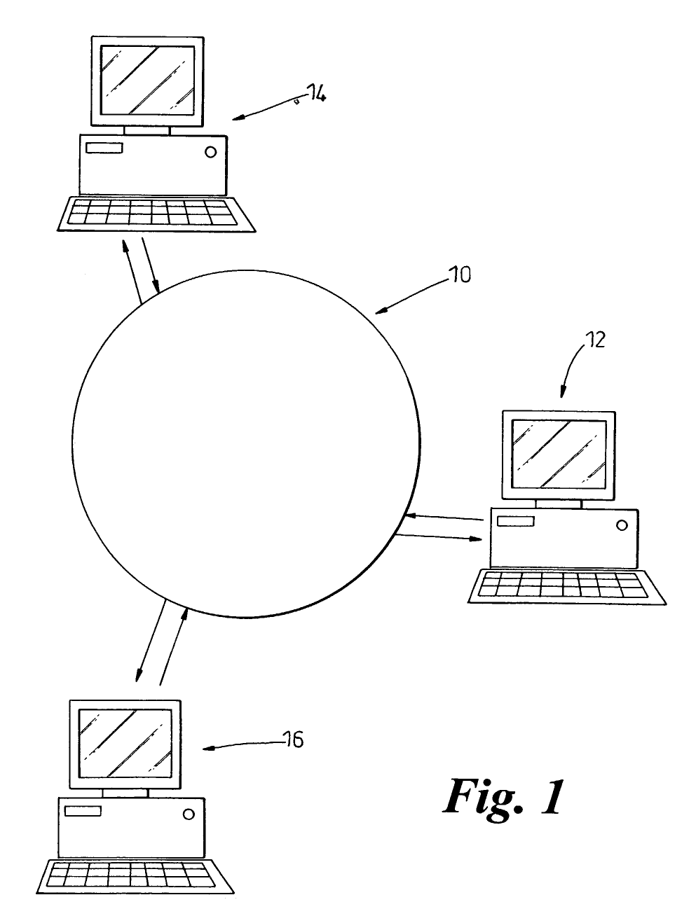

FIG. 1 is an overview of a network including a web server which performs the method of the first aspect of the present invention;

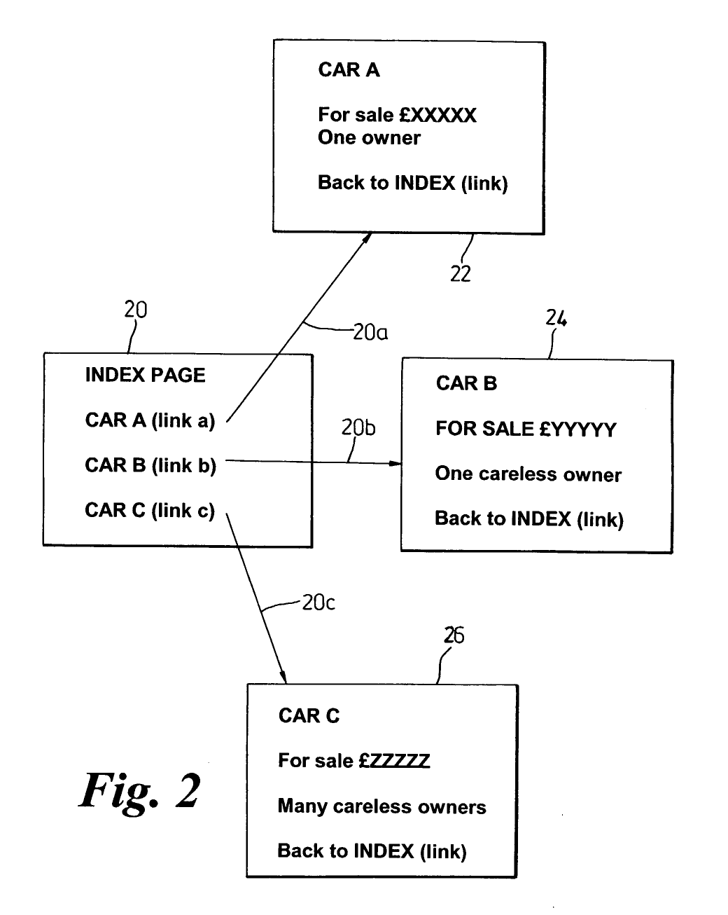

FIG. 2 is an illustration of four typical pages making up a Website stored in the memory of the web server;

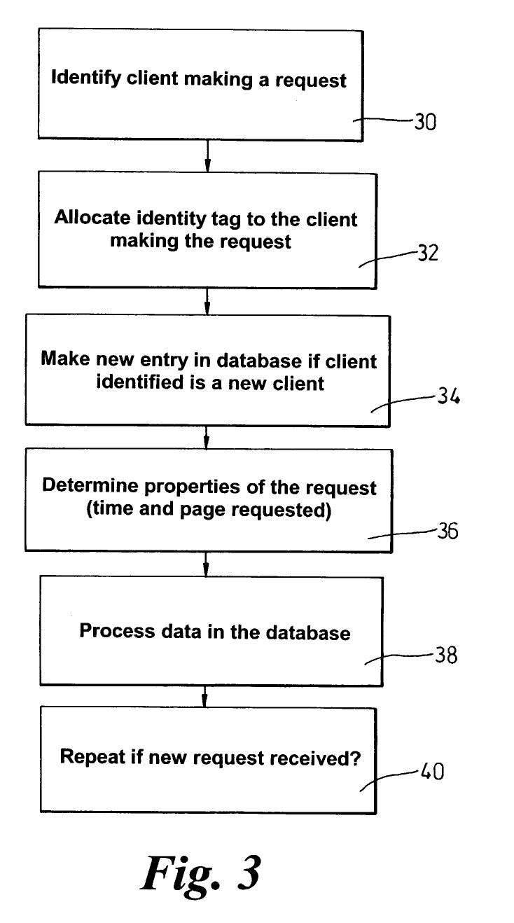

FIG. 3 sets out the sequence of steps performed in deciding whether or not a client making a request is a web server;

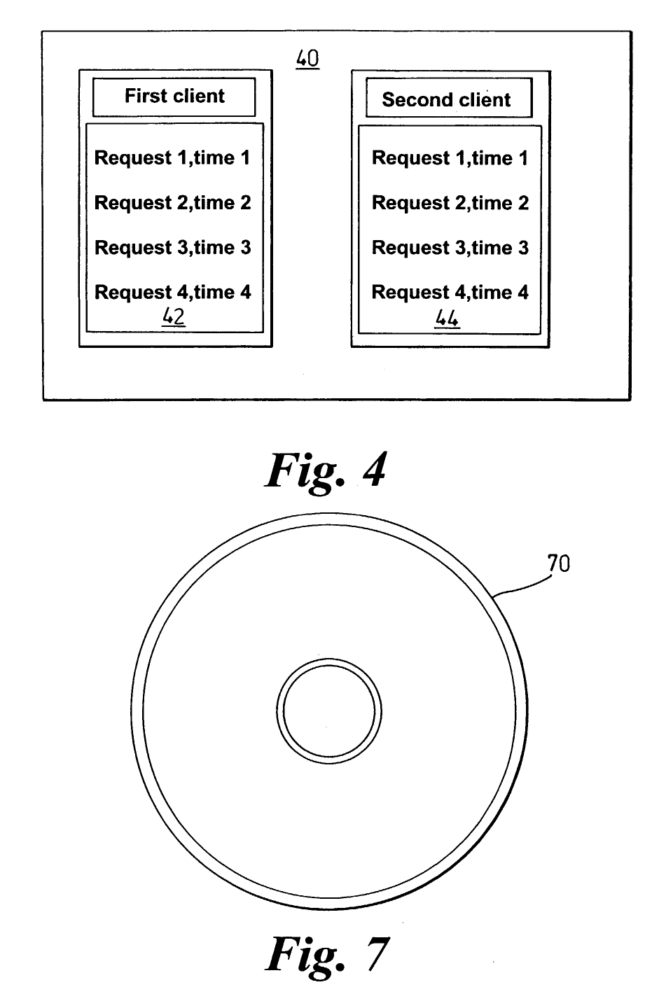

FIG. 4 is a representation of the contents of a database constructed during the processing of client requests made to the web server;

FIG. 5 sets out in more details the steps performed during analysis of the request information stored in the database;

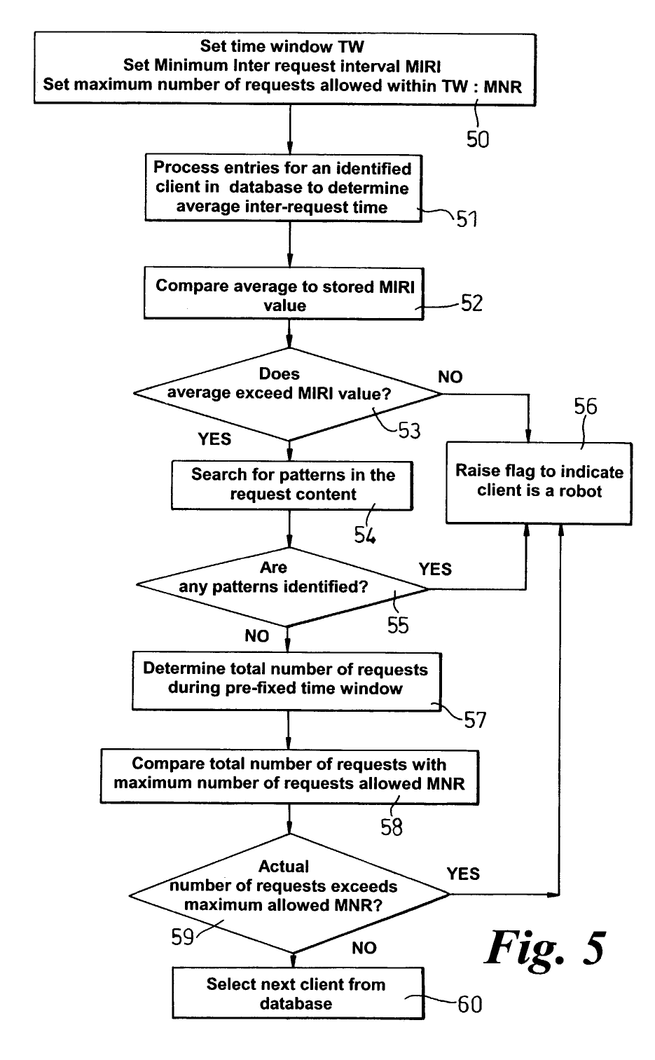

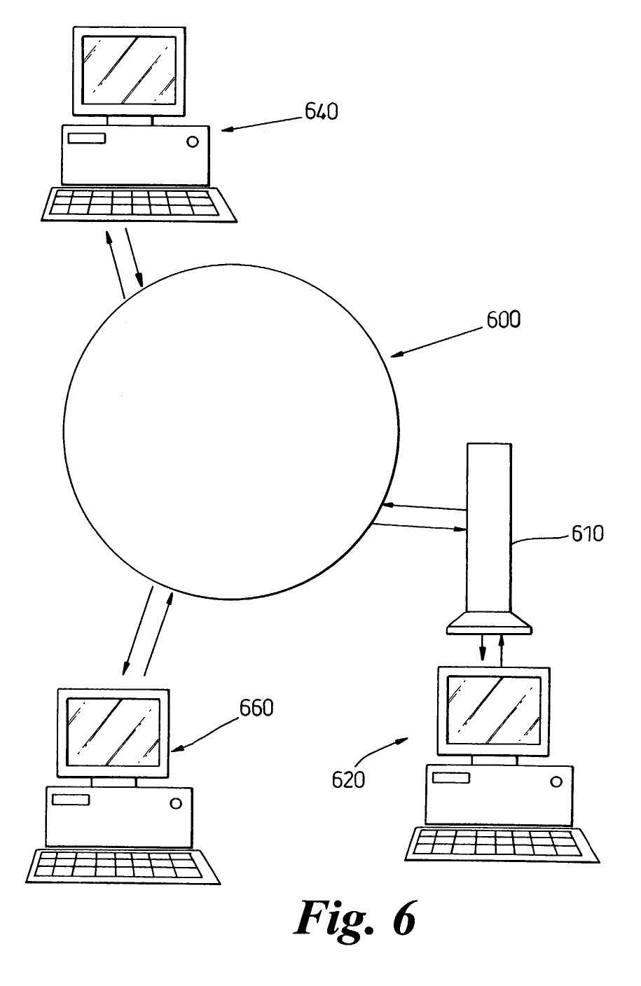

FIG. 6 is an overview of a different network which includes a facility for determining if a client making requests to a web server is a robot; and

FIG. 7 is an illustration of a data carrier which carries a set of program instructions which when executed on a processor cause the processor to carry out the method of the first aspect of the invention.

The network 10 illustrated in FIG. 1 comprises a web server 12 upon which is stored a Website, a first client server 14 which is being used by a genuine client of the website, and a second client server 16 which is running a web crawler, or robot, programme.

The clients 14,16 and the web server 12 communicate across the network 10 using the http: protocol, which allows the client servers 14,16 to request information stored on the web server 12 and for the web server 12 in turn to send the information to the client servers 14,16 upon request.

Each of the client servers 14,16 and the web server 12 may comprise a processor, such as the type sold under the name Pentiumg®, which runs instructions stored in an area of associated memory such as a hard drive. They will also include a display upon which webpage can be presented to a user, and an input device which permits a user to control the program executed by the processor. Connection of each server to the network in this example is through a dial-up connection modem with the network comprising a telecommunications connection between each server. The network may include optical fibres or the like.

The web server 12 differs from the client servers 14,16 in that it includes a web site stored on the web server memory. The web site comprises a set of different webpages which are each written in a mark-up language. A typical set of pages for the purpose of this embodiment are illustrated in FIG. 2 of the accompanying drawings. The pages 20,22,24,26 comprise an index page 20 and three sub-pages 22,24,26 containing information on a respective one of three cars. The index page 20 lists all three cars and is provided with three links 20a, 20b, 20c, with one link for each of the sub-pages 22,24,26. Similarly, each sub-page 22,24,26 contains only one link back to the main index page. In this example the links are hypertext links. Obviously, for other types of network the links may take other formats.

The second client server 16 also differs from the first client server 14 in that it includes a web crawler programme, commonly known as a robot stored in its memory. This comprises a software programme which runs on the processor of the second client server 16 that automatically—without human intervention-traverses the networks hypertext structure by recursively retrieving every web page available on the network 10 and parsing through each page in order to produce an index of the pages that are found. This index is also stored in the memory of the second client server 16.

In the simple example illustrated in FIG. 1 the second servers goal is to locate, parse and index each of the pages stored on the single web server connected to the network. This is undesirable for both the web server and the first client since it will take up bandwidth and other resources of the web server which will degrade the quality of service that the first client server is provided by the web server.

In use, each of the client servers may make a request to “get” one of the pages on the web server. To do so, a request is sent across the network which contains the network address of the web server and the relevant link for one of the four pages. Typically, this first request would be for the index page—the provider of the website making this address and link known through advertising or the like. Of course, the first request may be for a different page if the link is known to the client.

The owner of the website will typically receive requests from many hundreds or thousands of client servers, and to ensure that requests are always dealt with in a time efficient manner it is desirable to block requests made by the second server which is running a web crawler and allow requests made by the first server which is a genuine client.

To identify the second server, the web server operates a software program which logs the identity of all incoming requests made by client servers on the network along with the timing of these requests. The logged information is stored in a database held on the web server, although in alternative embodiments it could be stored elsewhere. The purpose of this piece of software is to analyse the stored request data over time in order to identify the second server which is a web crawler. Once identified the web server can then block access, or perhaps simply restrict access by the second server.

The software program performs a sequence of operations which are illustrated in FIG. 3 of the accompanying drawings.

In a first step 30, the identity of the client server making a request is determined, and the client server is allocated 32 an identity tag. An entry in the database is then established 34 whenever a new client server is identified. FIG. 4 illustrates in more detail the allocation of the identities and data to the database after four requests have been received from each of the client servers 14,16. In this example the first and second client servers 14,16 have been identified and entered on the database in two record sets 42,44.

Once the identity has been established, the properties of the request are determined 36. These properties include the time at which each request is received and the page which has been requested. The time can be determined easily by providing the web server with an internal real-time clock and checking the time on the clock whenever a request is received. This information is added to the database.

At periodic intervals the software program executes a routine to process the data in the database. This checking may be performed at 10 minute intervals, or perhaps less frequently. Alternatively it may be performed whenever a request is received and added to the database.

The steps of processing the data are illustrated in more detail in FIG. 5 of the accompanying drawings. In a first step 50 a set of reference values are generated and stored in memory. Of course, these values may be previously determined and pre-stored in the memory. These values include a time window value TW, a minimum inter-request interval MIRI, set maximum number of requests MNR allowed within the time window.

In the next step 51 all of the entries 42,44 in the database 40 corresponding to one of the clients are processed to determine the average inter-request time, i.e. the time between receipt of requests. This is performed by, for example, taking all the requests in order of their time of receipt and calculating the time between temporally adjacent requests, adding together all of the inter-request times and dividing by the number of periods between requests. Once the average has been calculated it is compared 52 to the stored minimum inter-request time value MIRI. In the event that the time is shorter than the acceptable value 53 the program raises 56 a flag next to the client in the database to indicate that it is a robot or web crawler.

If the average inter-request time exceeds the MIRI value, the program next analyses the type of requests made by the client. In this step the program searches 54 for patterns in the request. For example, suitable patterns will include whether the requests indicate that the client is systematically parsing through the linked pages in the order that they are stored, or perhaps in reverse order, or perhaps following every link in the order in which they appear on every page. If such a systematic request pattern is identified 55 the client is again marked 56 with a flag on the database as a robot.

In a further processing step, the total number of requests made within the time window TW is determined 57. This total number of requests is compared 58 with a maximum allowable number of requests MNR stored in memory and if it exceeds 59 MNR value a flag is again placed 56 in the database to indicate that a client is a web crawler.

Once each identification test has been completed and a flag placed 56 to indicate a client is a web server, the next client in the database is selected 60 processed in the same way, This continues until all clients in the database have been processed. If all tests are performed and no flags are placed then the process will also move on to the next client in the database.

The software program with the processor executing it therefore provide a robot identification system having an identification means adapted to identify a user requesting data from the networked server and allocate an identity tag to that user, a request monitoring means adapted to monitor the requests made to the server over time by the user identified by the tag, and a robot identifying means adapted to identify if the identified user is a robot based upon one or more properties of the requests made by that user that have been monitored by the request monitoring means wherein the one or more properties are predetermined to signify automation of the process of generating the requests.

It will be readily appreciated that the results produced by the software program comprise a database containing an identity tag for each client and a flag showing whether or not the client is believed to be a web crawler. The operator of the Website can then use this information however they see fit to help improve the quality of service they provide.

In an alternative embodiment illustrated schematically in FIG. 6 of the accompanying drawings a network 600 connects a web server 620 to a first client server 640 and a second client server 660. The software program which is used to identify robots is provided on a separate server 610 which intercepts or listens in to the requests made to the web server 620. This could be operated either by the operator of the web server or the owner of the Website installed on the web server or by a third party.

It will also be understood, of course, that the software program can be embodied in many different forms, and FIG. 7 is just one suitable example in which a data carrier, comprising a CD 70, is provided with the program instructions stored on it.

1. A method of identifying robots which are accessing a server, the method comprising:
allocating an identity tag to a user accessing data stored on the web server in order to identify that user;
monitoring the requests made to the server over time by the user identified by the tag;
and predicting whether the identified user is a robot based upon one or more properties of the monitored requests predetermined to signify automation of the process of generating the requests.

2. A method according to claim 1 in which the prediction of a user as a robot is based upon one or more of the following properties of the requests made by a user:
(a) the time between requests for data made by an identified user,
(b) the order in which data from the web server is requested by an identified user; and
(c) the number of requests made by a user in a given period of time.

3. The method of claim 2 in which all three of the properties (a), (b) and (c) are used together to identify robots.

4. A method according to an preceding claim in which the step of allocating an identity tag to a user comprise identifying the network address of the user.

5. A method according to claim 4 in which the identity tag is the same as the network address.

6. A method according to claim 2 in which property (a) at least is determined and in which the method includes the step of identifying a user as a robot when the time between requests for data is shorter than a predetermined minimum time.

7. A method according to claim 6 in which an average of the time between two or three or more subsequent requests is taken and the method makes a decision based upon the average time taken between requests.

8. A method according to claim 2 in which property (b) at least is determined and in which the method includes the step of identifying a user as a robot when the user requests data in a systematic manner which is to an extent independent of the content of the data.

9. A method according to claim 8 in which the requests are considered systematic where a user is systematically requesting every piece of data linked in a web page from the top of a requested page to the bottom, or from the bottom of a requested page to the top.

10. A method according to any preceding claim which further comprises storing the request information (user identity, request time and request content) in a database, and subsequently analysing the data in the database to identify robots.

11. A robot identification system for use in combination with a networked server, the system comprising:
an identification means adapted to identify a user requesting data from the networked server and allocate an identity tag to that user,
a request monitoring means adapted to monitor the requests made to the server over time by the user identified by the tag, and
a robot identifying means adapted to identify if the identified user is a robot based upon one or more properties of the requests made by that user that have been monitored by the request monitoring means wherein the one or more properties are predetermined to signify automation of the process of generating the requests.

12. A robot identification system according to claim 11 which includes a timer or counter which counts the elapsed time between subsequent requests made by a user.

13. A robot identification system according to claim 11 or claim 12 comprising a web server or on a separate server which is connected to a web server to which the user is making requests programmed according to an appropriate computer program.

14. A robot identification system according to claim 11 or 12 in which the server comprises a processor which intercepts requests from users prior to passing the requests on to a web server.

15. A robot identification system according to any one of claim 11 to 14 in which the request monitoring means is adapted to monitor:
(a) the time between requests for data made by an identified user,
(b) the order in which data from the web server is requested by an identified user; and
(c) the number of requests made by a user in a given period of time.

16. A robot identification system according to claim 15 which monitors all of (a), (b) and (c) to identify robots.

17. A robot identification system according to claim 15 or claim 16 in which an area of memory is provided into which the identity tags, inter-request times and total number of requests made are recorded and the identification means is adapted to process the information stored in this area of memory to determine if a user is a robot.

18. A computer program which when running on a processor is adapted to cause the processor to:
(i) allocate an identity tag to a user accessing data stored on the web server in order to identify that user,
(ii) monitor the requests made to the server over time by the user identified by the tag, and
(iii) predict whether the identified user is a robot based upon one or more properties of the monitored requests wherein the one or more properties are predetermined to signify automation of the process of generating the requests.

19. A data carrier which carries a computer program which when running on a processor is adapted to cause the processor to:
(i) allocate an identity tag to a user accessing data stored on the web server in order to identify that user,
(ii) monitor the requests made to the server over time by the user identified by the tag, and
(iii) predict whether the identified user is a robot based upon one or more properties of the monitored requests wherein the one or more properties are predetermined to signify automation of the process of generating the requests.
